(19) United States
(12) Patent Application Publication
(10) Pub. No.: US 2025/0365767 A1
(43) Pub. Date: Nov. 27, 2025

(54) APPARATUS AND METHOD FOR CONTROLLING WI-FI CHANNEL ACCESS

(71) Applicant: ELECTRONICS AND TELECOMMUNICATIONS RESEARCH INSTITUTE, Daejeon (KR)

(72) Inventors: Young Keun YOON, Daejeon (KR); Ho Kyung SON, Daejeon (KR); Hyoil KIM, Daejeon (KR); Suhwan JUNG, Daejeon (KR); Seokwoo CHOI, Daejeon (KR)

(73) Assignee: ELECTRONICS AND TELECOMMUNICATIONS RESEARCH INSTITUTE, Daejeon (KR)

(21) Appl. No.: 19/205,420

(22) Filed: May 12, 2025

(30) Foreign Application Priority Data
May 24, 2024 (KR) 10-2024-0067762

(51) Int. Cl. H04W 74/0816; H04W 76/15; H04W 88/08

(52) U.S. Cl. CPC H04W 74/0816; H04W 76/15; H04W 88/08

(57) ABSTRACT

Provided is an apparatus for controlling Wi-Fi channel connection which includes a wireless communication circuit configured to provide multiple links and be capable of multi-link operation, and a processor configured to be functionally connected to the wireless communication circuit, wherein the processor identifies types of devices connected to the multiple links at a specified time point, and assigns different minimum contention window (CW) values to the connected devices according to the identified types.

### CROSS-REFERENCE TO RELATED APPLICATION

This application claims priority to and the benefit of Korean Patent Application No. 10-2024-0067762, filed on May 24, 2024, the disclosure of which is incorporated herein by reference in its entirety.

### BACKGROUND

### 1. Field of the Invention

Various embodiments disclosed in this document relate to media access control technology.

### 2. Discussion of Related Art

In the Carrier Sense Multiple Access/Collision Avoidance (CSMA/CA) medium access control method, to minimize collisions in data transmission between a plurality of devices and a single AP, data is transmitted after waiting for a predetermined waiting time. Specifically, each terminal waits for a random waiting time (contention window (CW) value) and then transmits data.

A legacy Wi-Fi device (hereinafter referred to as “existing Wi-Fi device”) can use back-off techniques which reduce a collision probability by changing the CW (hereinafter referred to as “contention window”) value in a constant or adaptive manner based on a collision probability value calculated according to the states of a channel and a network after packet transmission according to the priority in order to increase transmission performance. At this time, the existing Wi-Fi device gave a differentiated priority for each service category and guaranteed relatively high transmission performance for data with high priority.

The existing Wi-Fi device performs single-link operation (SLO) to communicate with one device at one time point. For example, even when an existing Wi-Fi access point uses two frequency bands of 2.4 GHz and 5 GHz, a device connected to the existing Wi-Fi access point transmits and receives data using only one of the two frequency bands. Therefore, channel access techniques of collision avoidance and priority for the existing Wi-Fi devices are designed to suit SLO.

Recently, next-generation Wi-Fi devices have emerged to improve throughput and transmission speed performance. These next-generation Wi-Fi devices perform multi-link operation (MLO) to transmit multiple data streams simultaneously using multiple antennas. For example, as to the next-generation Wi-Fi devices (e.g., access points and multi-link devices), a single device connected to the next-generation Wi-Fi devices can use multiple frequency bands simultaneously through MLO. In this regard, a channel access technique has been proposed in which the next-generation Wi-Fi devices (e.g., access points) can intelligently adjust the back-off mechanism through a back-off coordinator.

### SUMMARY OF THE INVENTION

However, in an environment where a multi-link device (MLD) and the existing Wi-Fi device (SLD, station) coexist, the multi-link operation (MLO) can significantly degrade the transmission performance of the MLD coexisting on the same channel link compared to the transmission performance of a single-link device.

Various embodiments disclosed in this document are directed to providing a Wi-Fi channel access control device and method that can improve fairness in a coexistence situation of a multi-link device and a single-link device.

According to an aspect of the present invention, there is provided an apparatus for controlling Wi-Fi channel access, which includes a wireless communication circuit configured to provide multiple links and capable of multi-link operation, and a processor configured to be functionally connected to the wireless communication circuit, wherein the processor identifies the types of devices connected to the multiple links at a specified time point, and assigns different minimum contention window (CW) values to the connected devices according to the identified types.

According to another aspect of the present invention, there is provided a method of controlling channel access by an AP multi-link device, which includes identifying types of devices connected to multiple links at a specified time point, and assigning different minimum CW values to the connected devices according to the identified types.

According to still another aspect of the present invention, there is provided an apparatus for controlling Wi-Fi channel access which includes a wireless communication circuit configured to be capable of multi-link operation through multiple links, a memory configured to store at least one instruction, and a processor configured to be functionally connected to the wireless communication circuit and the memory, wherein the at least one instruction causes, when executed, the processor to identify the types of devices connected to the multiple links at a specified time point, and to assign different minimum CW values to the connected devices according to the identified types.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a configuration diagram illustrating a multi-link device according to an embodiment;

FIG. 2 is a structural diagram illustrating a multi-link state in which two links are provided according to an embodiment;

FIG. 3 is a structural diagram illustrating a multi-link state in which three links are provided according to an embodiment;

FIG. 4 is a structural diagram illustrating a multi-link status in which a plurality of devices is connected to each of two links according to an embodiment;

FIG. 5 is a structural diagram illustrating a multi-link state in which three links are provided according to an embodiment;

FIG. 6 is a configuration diagram illustrating an apparatus for controlling channel access according to an embodiment;

FIG. 7 illustrates a transmission situation when the same minimum contention window (CW) value is set to all connected devices in multiple links;

FIG. 8 illustrates a transmission situation when a minimum CW value is assigned according to a device type according to an embodiment;

FIG. 9 is a schematic flowchart illustrating a method of controlling channel access according to an embodiment; and

FIG. 10 is a detailed flowchart illustrating a method of controlling channel access according to an embodiment.

In relation to the description of drawings, like reference numerals may be used for like components.

### DETAILED DESCRIPTION OF EXEMPLARY EMBODIMENTS

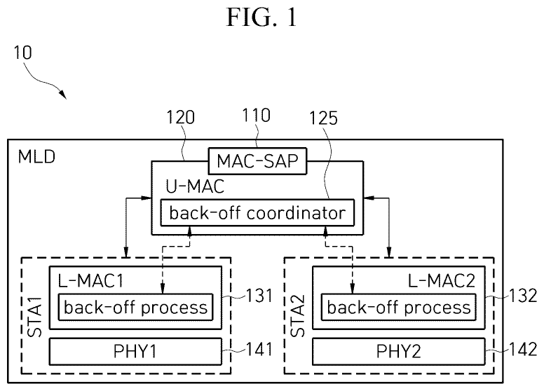

FIG. 1 is a configuration diagram illustrating a multi-link device according to an embodiment.

Referring to FIG. 1, a multi-link device 10 according to an embodiment may include a medium access control-service access point (MAC-SAP) 110, an upper-MAC (U-MAC) layer 120, a plurality of lower MAC (L-MAC) layers 131 and 132, and a plurality of physical (PHY) layers 141 and 142 in a communication module. In FIG. 1, a first station STA 1 and a second station STA 2 may each be some of communication modules capable of performing communication via multiple links (Wi-Fi links) simultaneously or non-simultaneously.

The MAC-SAP 110 exists in a logical link control (LLC) layer and provides an interface for managing communication between upper and lower layers. When receiving a packet from an upper layer, the MAC-SAP 110 may convert the received packet into a MAC frame and transmit the converted MAC frame to the PHY layers 141 and 142. Conversely, the MAC-SAP 110 may convert the MAC frame from the lower layer into a packet and transmit the converted packet to the upper layer.

The U-MAC layer 120 includes a back-off coordinator 125, and controls a back-off process of the L-MAC layers 131 and 132 through the back-off coordinator 125.

The L-MAC layers 131 and 132 may respectively process data transmission and reception for at least one link of access point. For example, a first L-MAC layer may perform data transmission and reception through a primary link of the access point, and a second L-MAC layer may perform data transmission and reception through a secondary link of the access point. The L-MAC layers 131 and 132 may perform the back-off process under the control of the back-off coordinator 125. The back-off process may be a process of delaying or adjusting the medium access time for a random period to avoid a plurality of devices from transmitting data simultaneously.

When receiving the MAC frame from the U-MAC layer 120, the PHY layers 141 and 142 may modulate the received MAC frame and respectively transmit the modulated MAC frame wirelessly through at least one antenna corresponding to multi-link. Conversely, when receiving a wireless signal from another device connected to the multi-link through at least one antenna, the PHY layers 141 and 142 may demodulate the received wireless signal, convert the demodulated signal into a MAC frame, and then transmit the converted MAC frame to the U-MAC layer 120.

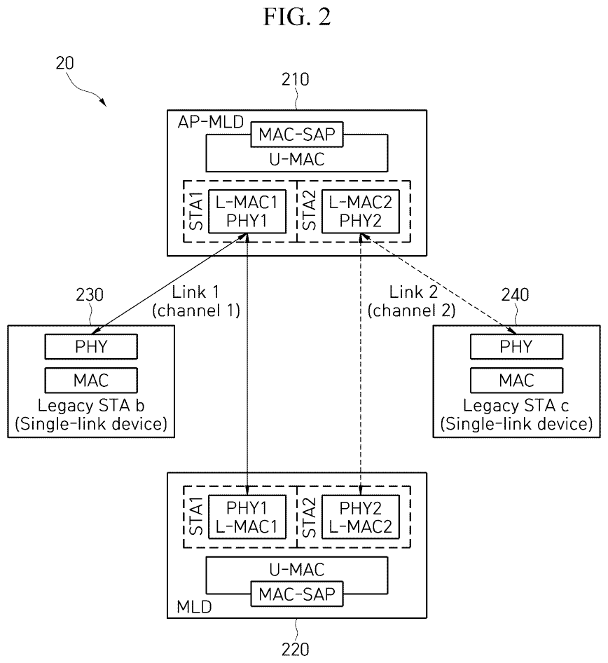

The multi-link operation includes a simultaneous transmit and receive (STR) operation mode and non-STR mode. The STR mode refers to a simultaneous transceiver mode or asynchronous mode. In the STR mode, two or more links may be operated completely independently and do not interfere with each other. The non-STR mode refers to a non-simultaneous transceiver mode or synchronous mode. In the non-STR mode, since reception and transmission are not allowed at the same time, all links can receive or transmit data at one time point. In non-STR mode, when data is transmitted from the primary link, the secondary link enters a blindness state to prevent the secondary link from sensing the channel status. Therefore, the secondary link is unable to sense the channel status, cannot participate in channel access competition, and cannot receive data. The multi-link device 10 may be an AP multi-link device (e.g., 210 in FIG. 2) or a non-AP multi-link device (e.g., 220 in FIG. 2). According to the IEEE 802.11be (Wi-Fi 7) standard, the AP multi-link device (e.g., 210 in FIG. 2) is required to operate in the STR mode, but the non-AP multi-link device (e.g., 220 in FIG. 2) may not be able to operate in the STR mode due to performance constraints. Assuming this case, an example in which the AP multi-link device (e.g., 210 in FIG. 2) operates in the STR mode and the non-AP multi-link device (e.g., 220 in FIG. 2) operates in the non-STR mode will be described in the present document.

The back-off coordinator 125 may control the back-off process of the L-MAC layers 131 and 132 in each station STA in the multi-link device 10. When the multi-link device 10 attempts transmission through the primary link due to transmission (TX) power leakage while operating in the non-STR mode (in the case of the non-AP multi-link device), the secondary link may be switched to the blindness state and become unable to sense the channel. For example, when transmission is attempted through the primary link while a frame is already being received through the secondary link, a collision in which an unwanted interference signal is received due to TX power leakage of the secondary link may occur, resulting in failure to receive the frame. As a result, when transmission is attempted through one link while the multi-link device 10 is operated in the non-STR mode (in the case of the non-AP multi-link device), an adjacent link may not be used, resulting in inefficient use of the channel.

In an embodiment, this problem can be solved by assigning a smaller minimum CW value to the non-AP multi-link device than a minimum CW value assigned to the AP multi-link device and a single-link device (legacy station). This will be described below with reference to FIG. 2.

FIG. 2 is a structural diagram illustrating a multi-link state in which two links are provided according to an embodiment.

Referring to FIG. 2, a multi-link system according to an embodiment may include a single access point (AP) multi-link device 210, two legacy stations 230 and 240, and one multi-link device 220.

According to an embodiment, the AP multi-link device 210 and the multi-

link device 220 are configured to provide logical multiple interfaces between the PHY layer and the L-MAC layer utilizing their respective MAC-SAPs. The AP multi-link device 210 and the multi-link device 220 may simultaneously connect to the primary link or the secondary link to transmit and receive data.

According to an embodiment, the AP multi-link device 210 may provide two simultaneously connectable links (primary link and secondary link). The primary and secondary links of the AP multi-link device 210 may each be connected to one multi-link device 220 and the two legacy stations 230 and 240. The links mentioned in the following document may correspond to Wi-Fi wireless communication channels using different frequency bands.

The multi-link device 220 may be connected to two or more wireless communication channels in the AP multi-link device 210, and thus may be connected to the primary link and the secondary link. The multi-link device 220 may be a Wi-Fi client terminal capable of multi-link operation, such as a personal computing device including a smartphone, laptop, or tablet.

The legacy stations 230 and 240 may be single-link devices (SLDs) that utilize single-link operation. The legacy stations 230 and 240 may be each client terminal capable of Wi-Fi communication in a single-link operation mode. For example, the first legacy station 230 may be connected to the primary link, and the second legacy station 240 may be connected to the secondary link.

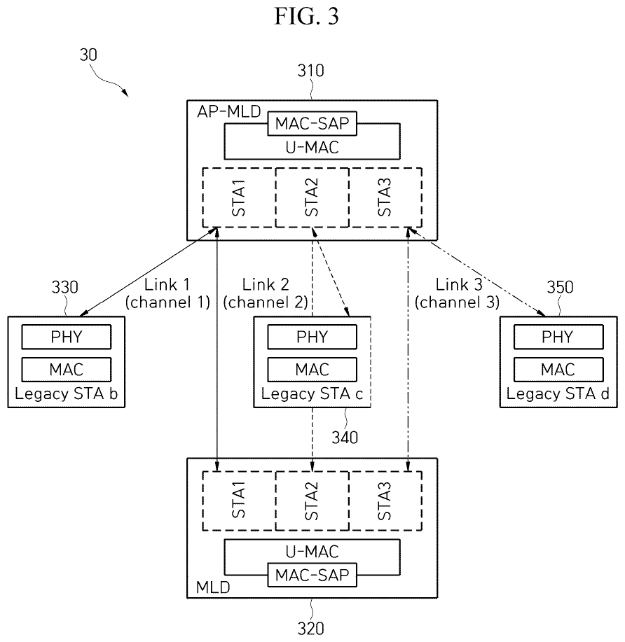

FIG. 3 is a structural diagram illustrating a multi-link state in which three links are provided according to an embodiment.

Referring to FIG. 3, a multi-link system 30 according to an embodiment may include a single AP multi-link device 310, three legacy stations 330, 340, and 350, and one multi-link device 320.

According to an embodiment, the AP multi-link device 310 may provide a first link, a second link, and a third link that are simultaneously accessible. Each of the legacy stations 330, 340, and 350 may be connected to the first link, the second link, and the third link, respectively. The multi-link device 320 supports connection to the three links, so that the multi-line device 320 may be connected to the first link, the second link, and the third link simultaneously.

Therefore, in FIG. 3, the multi-link device 310 may transmit/receive data through three links simultaneously, and the legacy stations 330, 340, and 350 may transmit and receive data through the first link, the second link, and the third link, respectively.

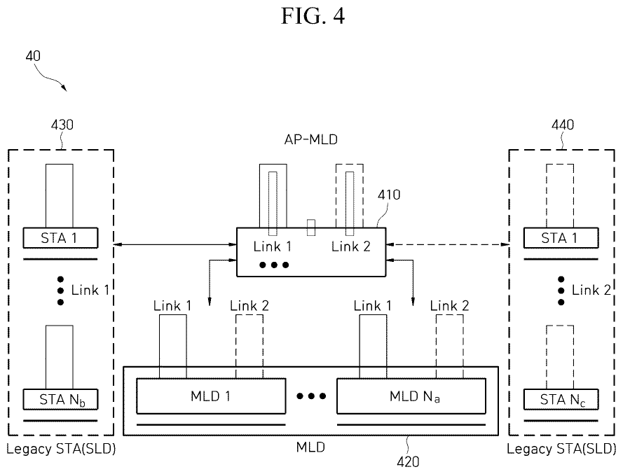

FIG. 4 is a structural diagram illustrating a multi-link status in which a plurality of devices is connected to each of two links according to an embodiment.

Referring to FIG. 4, a multi-link system 40 according to an embodiment may include a single AP multi-link device 410, a plurality of legacy stations 430 and 440, and a plurality of multi-link devices 420.

The single AP-multi-link device 410 may provide a primary link and a secondary link that are simultaneously accessible.

The plurality of first legacy stations 430 may be connected to the primary link to perform data multiplexing through the primary link. The plurality of second legacy stations 440 may be connected to the secondary link to perform data multiplexing through the secondary link.

The plurality of multi-link devices 420 may be simultaneously connected to the primary and secondary links, respectively, to perform data multiplexing through the primary link and the secondary link.

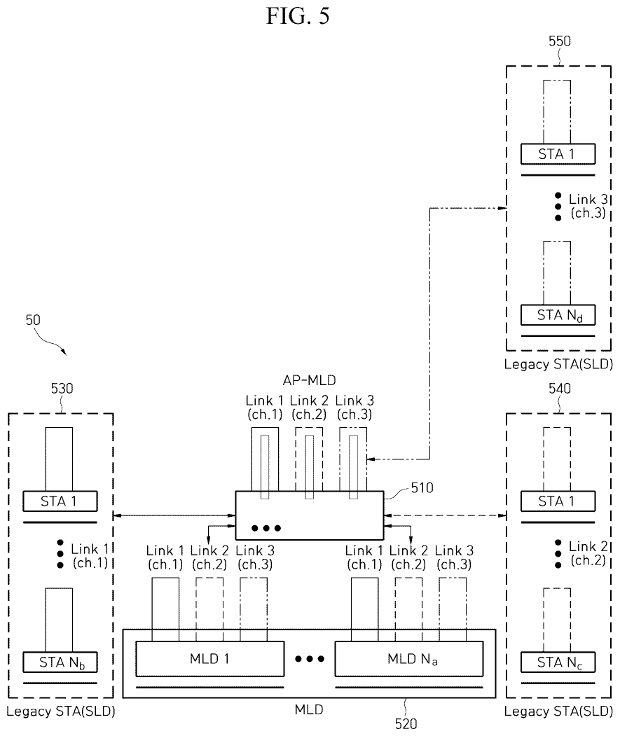

FIG. 5 is a structural diagram illustrating a multi-link state in which three links are provided according to an embodiment.

Referring to FIG. 5, a multi-link system 50 according to an embodiment may include a single AP multi-link device 410 providing three links, a plurality of legacy stations 530, 540, and 550, and a plurality of multi-link devices 520 each providing three links.

The single AP-multi-link device 510 may provide a primary link, a secondary link, and a ternary link that are simultaneously accessible.

The plurality of first legacy stations 530 may be connected to the primary link to perform data multiplexing through the primary link. The plurality of second legacy stations 540 may be connected to the secondary link to perform data multiplexing through the secondary link. The plurality of third legacy stations 550 may be connected to the ternary link to perform data multiplexing through the ternary link.

The plurality of multi-link devices 520 are connected to the primary to ternary links simultaneously to perform data multiplexing through the primary to ternary links.

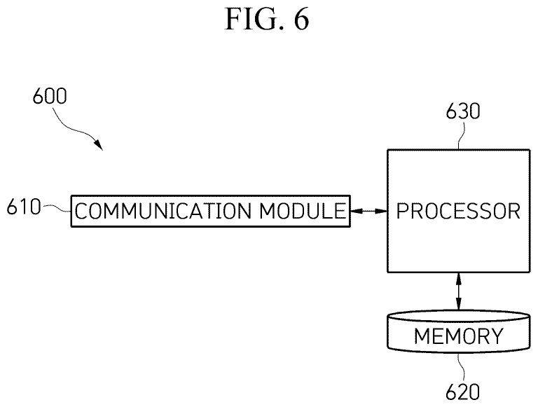

FIG. 6 is a configuration diagram illustrating an apparatus for controlling channel access according to an embodiment.

Referring to FIG. 6, an apparatus 600 for controlling channel access according to an embodiment may include a communication module 610, a memory 620, and a processor 630. In an embodiment, the apparatus 600 for controlling channel access may omit some components or may further include additional components. In addition, some of the components of the apparatus 600 for controlling channel access may be combined into a single entity, but perform the functions of the corresponding components in the same manner before combining. In an embodiment, the apparatus 600 for controlling channel access may be an AP multi-link device.

The communication module 610 may support the establishment of a communication channel or a wireless communication channel between the apparatus 600 for controlling channel access and other devices (e.g., a multi-link device and a single-link device (e.g., the legacy station 230 in FIG. 2)), and the performance of communication through the established communication channel. The communication channel may include, for example, a Wi-Fi communication channel. The communication module 610 may be a wireless communication circuit that provides a plurality of links and is capable of multi-link operation. The communication module 610 may provide multiple links capable of two or more channel connections.

The memory 620 may include various types of volatile memory or non-volatile memory. For example, the memory 620 may include a read only memory (ROM) and a random access memory (RAM). In an embodiment, the memory 620 may be located inside or outside the processor 630, and may be connected to the processor 630 through various already known means. The memory 620 may store a variety of data used by at least one component (e.g., the processor 630) of the apparatus 600 for controlling channel access. The data may include, for example, input data or output data for software and the related commands. For example, the memory 620 may store at least one instruction and data for channel access control.

The processor 630 may control at least one other component (e.g., hardware or software component) of the apparatus 600 for controlling channel access and perform various data processing or computational operations. The processor 630 may include, for example, at least one of a central processing unit (CPU), a graphics processing unit (GPU), a microprocessor, an application processor, an application specific integrated circuit (ASIC), and a field programmable gate array (FPGA), and have a plurality of cores.

The processor 630 periodically transmits a beacon frame to connected devices (e.g., a single-link device (e.g., 230 in FIG. 2)) and a multi-link device) to perform initialization and synchronization. In this case, the connected devices may determine a bandwidth based on the beacon frame and then transmit a data frame to the apparatus 600 for controlling channel access according to the bandwidth.

The processor 630 calculates an uplink transmission speed for each connected device based on the data frame received from each connected device, and transmits or misses an acknowledge (ACK) for the data frame according to reception ACK configured for each transmission speed.

In this regard, each connected device may adjust the size of a CW based on the ACK for the data frame and transmit a new data frame or previously transmitted data to the apparatus 600 for controlling channel access. For example, each connected device may increase the size of the CW whenever the ACK is missed, and as a result, the channel usage time of the device may be reduced. The CW value starts from the minimum CW value and may gradually increase depending on the number of retransmission attempts. A random back-off time is the time to postpone medium access to reduce a possibility of collisions between stations trying to access the medium immediately after the transmission of the last frame is completed. The random back-off time is generated by Equation of random * slot time. Here, random is an integer value selected from the range of CW (values existing in the range from the minimum CW to the maximum CW). A station with a small back-off time initially has a higher possibility of accessing the medium.

According to an embodiment, the processor 630 may assign a CW value of each connected device to devices connected to the links of the communication module 610 by performing a fairness analysis on the devices. The fairness analysis may be performed periodically (e.g., at the time of transmitting a beacon frame), for example, after the initialization of the apparatus 600 for controlling channel access. Additionally, the fairness analysis may be performed when a new device is connected to the apparatus 600 for controlling channel access.

For example, the processor 630 may identify the types of the connected devices while performing fairness analysis, and assign different minimum CW values for each of the identified types. The types of the devices may include a multi-link device (non-AP multi-link device), a single-link device, and an AP multi-link device.

According to an embodiment, when starting the fairness analysis operation, the processor 630 may determine whether a new multi-link device is connected to the communication module 610. When a new multi-link device exists, the processor 630 may initialize the minimum CW value of the new multi-link device. For example, the processor 630 may set a specified default value as the minimum CW value of the multi-link device. The specified default value may be the minimum CW value of a specified (or, already connected to the communication module 610) single-link device (legacy station).

In an embodiment, the processor 630 may determine whether the new device is a multi-link device or a single-link device based on information transmitted and received during the process of connecting the new device to the communication link. For example, the processor 630 may distinguish whether the new device is a newly connected multi-link device and whether the multi-link device will perform a multi-link operation, based on information included in an association request/response frame transmitted and received during the process of communicating with the device connected to the communication link.

According to an embodiment, the processor 630 may initialize the minimum CW value and then initialize and set packet transmit opportunity (TXOP) (TXOP=0). As a result, packet transmission between the apparatus 600 for controlling channel access and the new multi-link device may be stopped.

According to an embodiment, the processor 630 may determine whether there is a single-link device (SLD) (legacy station) to transmit/receive data through the link of the communication module 610 after initializing the minimum CW value.

When it is determined that there is the single-link device to transmit/receive data, the processor 630 may change and designate the minimum CW value of the multi-link device to be smaller than the specified default value (less than the CW value of the legacy station).

On the other hand, when it is determined that there is no single-link device to transmit/receive data, the processor 630 may assign the minimum CW value of the multi-link device to be smaller than the minimum CW value of the apparatus 600 for controlling channel access. Since the apparatus 600 for controlling channel access (AP multi-link device) operates in the STR mode, channel access may be relatively easier than that of a non-AP multi-link device which is operated in the non-STR mode, and which is connected to the apparatus 600 for controlling channel access. Therefore, the minimum CW value of the non-AP multi-link device may be set to be less than the minimum CW value of the apparatus 600 for controlling channel access is set.

According to an embodiment, the processor 630 may assign the CW window value and then grant a packet transmission opportunity (TXOP=1) between the apparatus 600 for controlling channel access and the multi-link device.

According to an embodiment, the processor 630 may perform a fairness analysis for each device based on data throughput. For example, the processor 630 may calculate Jain's fairness index using data throughput and analyze fairness for each device based on the calculated fairness index. The Jain's fairness index F is one of indexes for evaluating fairness of resource distribution among multiple users or devices, and may be calculated using data throughput as shown in the following Equation 1.

$$F = \frac{{( {\sum }_{i = 1}^{n} {x}_{i} )}^{2}}{n \cdot {\sum }_{i = 1}^{n} {x}_{i}^{2}} \qquad [ Equation 1 ]$$

Here, n denotes the number of connected devices, and xᵢ may be the amount of resources (or data throughput) allocated to the devices.

According to various embodiments, the processor 630 may re-adjust the minimum CW value after completing the fairness analysis. For example, when there is a difference greater than a threshold in the fairness between the connected devices, the processor 630 may set, to be smaller, the minimum CW value of the multi-link device (e.g., 210 in FIG. 2) or link with low data throughput.

In the above-described embodiment, when there is a single-link device connected to the communication module 610, the processor 630 may also set its own minimum CW value to be less than the minimum CW value of the single-link device.

According to various embodiments, the processor 630 may assign different minimum CW values even to the same type of devices among the connected devices based on at least one classification criterion among the traffic category, the network environment per link (number of connected devices, channel status), the traffic category per link, and the performance of each device. Accordingly, the apparatus 600 for controlling channel access according to an embodiment may improve fairness of the connected devices and the links.

According to an embodiment, the processor 630 may grant a priority to each traffic category and assign a smaller minimum CW value to traffic with a higher priority, thereby more preferentially transmitting the corresponding traffic. For example, in the IEEE 802.11ax (Wi-Fi 6) standard, the minimum CW values may be assigned for each traffic category as shown in Table 1. Based on the above standard, the processor 630 may assign a lower minimum CW value to traffic with a higher priority in the traffic category even in the case of the same type of devices.

TABLE 1

| | | Minimum |
|---|---|---|
| traffic category | Description | CW value |
| Voice (VO) | Real-time voice traffic | 3 |
| Video (VI) | Real-time video streaming traffic | 7 |
| Best Effort (BE) | General data transmission traffic | 15 |
| Background (BK) | Data transmission traffic of background | 15 |
| | application | |

According to an embodiment, the processor 630 may set the minimum CW value to improve fairness of network environments of each link. For example, the number of devices coexisting in the primary link of the communication module 610 may be larger (or the channel state of the primary link may be poor), and the number of devices coexisting in the second link may be relatively smaller (or the channel status of the secondary link may be good). In this case, the processor 630 may assign a smaller minimum CW value to a link in a relatively disadvantageous network environment (a case in which the number of coexisting devices is large or the channel status is poorer) among a plurality of links than a CW value assigned to a link in a relatively advantageous network environment. Accordingly, the processor 630 may improve the fairness or the links.

According to an embodiment, the processor 630 may assign the minimum CW value according to the traffic category for each link to improve fairness for each link. For example, when the category (priority) of traffic to be transmitted for each link is different, the processor 630 may assign different minimum CW values to each link according to the traffic category to be transmitted for each link.

According to various embodiments, the processor 630 may re-adjust the minimum CW value after completing the fairness analysis to improve the fairness. For example, the processor 630 may re-adjust the minimum CW value for the connected devices immediately after the fairness analysis or at the time of the next fairness analysis. In the latter case, the processor 630 may store the analyzed fairness analysis result (fairness index) in the memory 620, and assign the minimum CW value further based on the fairness index stored when the minimum CW value is assigned before the next fairness analysis.

In this manner, the apparatus 600 for controlling channel access according to an embodiment may secure the fairness between the legacy station and the multi-link device in a multi-link operation environment where the legacy station and the multi-link device coexist.

In addition, the apparatus 600 for controlling channel access according to an embodiment may improve the fairness between the devices or the links in an environment where multi-link devices and single-link devices coexist by granting a higher priority (or assigning a lower minimum CW value) to the link or device with relatively low performance (e.g., data throughput).

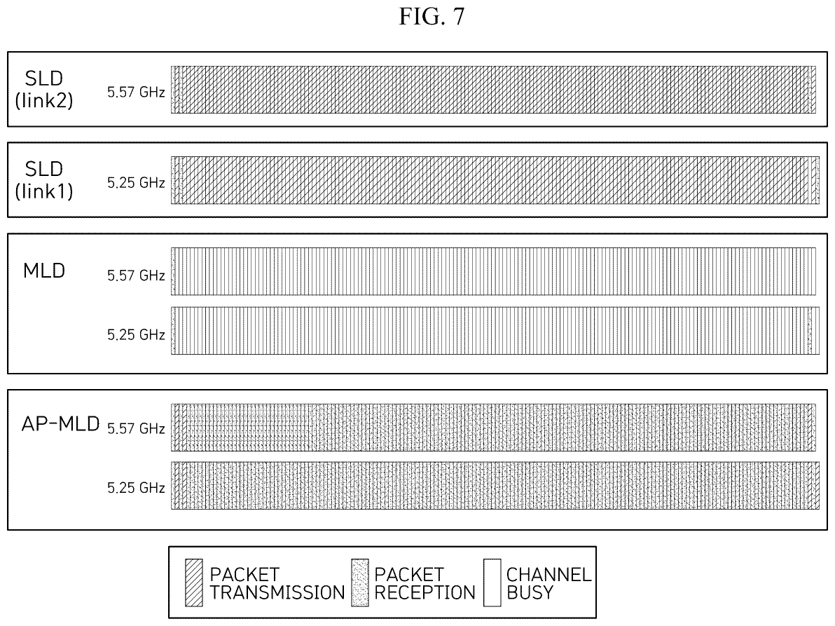

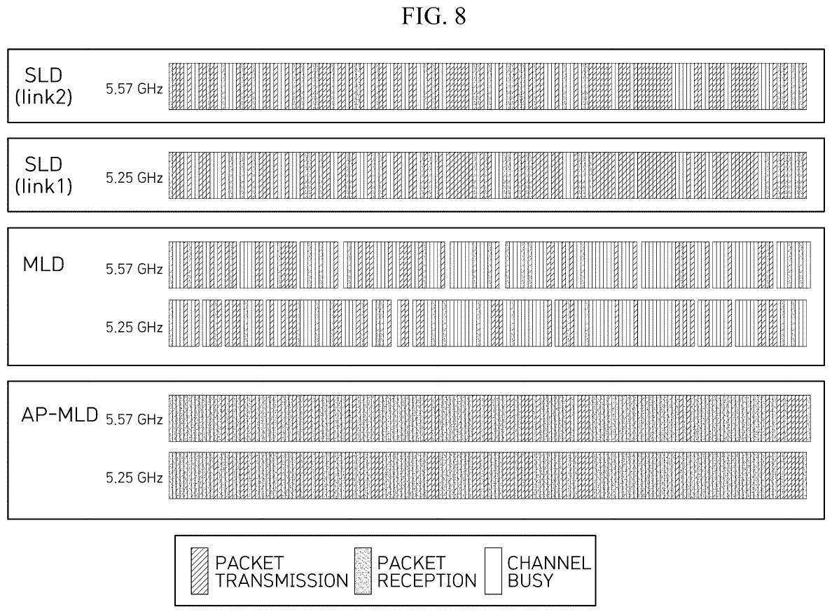

FIG. 7 illustrates a transmission situation when the same minimum CW value is set to all connected devices in multiple links, and FIG. 8 illustrates a transmission situation when a minimum CW value is assigned according to a device type according to an embodiment. In FIGS. 7 and 8, an example in which a primary link performs communication in a frequency band of 5.57 GHz, a secondary link performs communication in a frequency band of 5.25 GHz, two legacy stations (single-link devices) are connected to the first and second links, respectively and one multi-link device is multi-connected to the first and second links. In FIGS. 7 and 8, the dotted boxes are sections where packet reception is performed, the hatched boxes are sections where packet transmission is performed, and the white boxes are sections where transmission is not possible because the channel is busy.

As illustrated in FIG. 7, when the multi-link device and the legacy station (existing Wi-Fi device) have the same minimum CW value, it can be seen that the legacy station occupies most of the transmission opportunities, so that the AP multi-link device (e.g., the apparatus 600 for controlling channel access in FIG. 6) and the multi-link device hardly transmit data.

On the other hand, as illustrated in FIG. 8, when a lower minimum CW value than that of the legacy station is assigned to the multi-link device and the AP multi-link device, it can be seen that the multi-link device and the AP multi-link device have similar transmission opportunities, so that they exhibit similar throughput performance.

In this manner, it can be seen that the fairness performance can be improved in an MLO environment where the legacy station and the multi-link device coexist according to the assignment of the minimum CW value according to an embodiment.

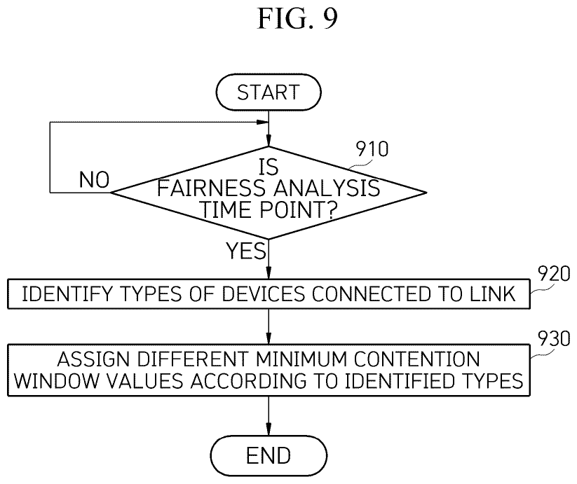

FIG. 9 is a schematic flowchart illustrating a method of controlling channel access according to an embodiment.

Referring to FIG. 9, in operation 910, the apparatus 600 for controlling channel access may determine whether the apparatus is at a specified fairness analysis time point. The specified fairness analysis time point may include, for example, an initialization time point of the apparatus 600 for controlling channel access or at least one time point during a beacon transmission period.

In operation 920, the apparatus 600 for controlling channel access may identify the types of devices connected to a plurality of communication links when the apparatus is at the specified fairness analysis time point.

In operation 930, the apparatus 600 for controlling channel access may assign different minimum CW values of the connected devices for each of the identified types. For example, the apparatus 600 for controlling channel access may assign the minimum CW value of the multi-link device connected to the communication links to be less than the minimum CW value of the single-link device connected to the communication links. As another example, the apparatus 600 for controlling channel access may assign the minimum CW value of the multi-link device to be less than the minimum CW value of the AP multi-link device when there is no single-link device connected to the communication links.

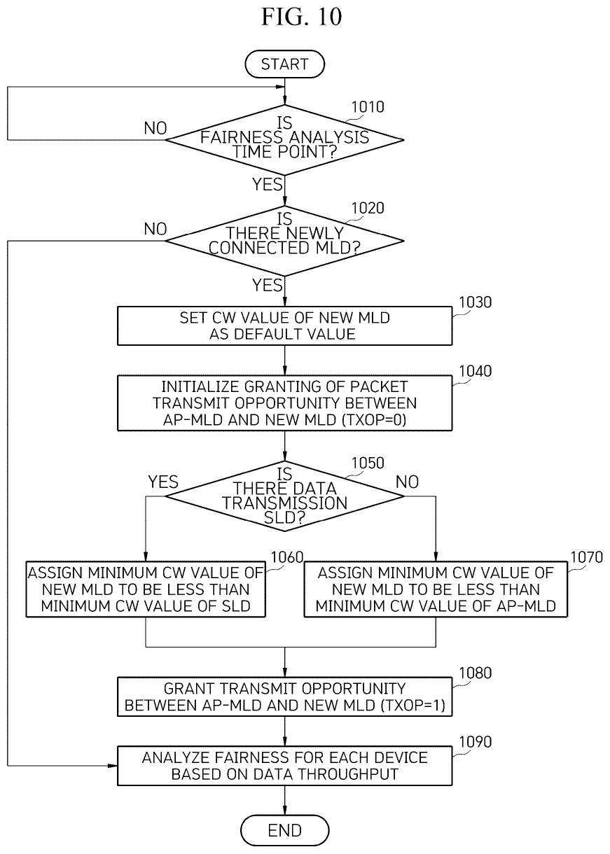

FIG. 10 is a detailed flowchart illustrating a method of controlling channel access according to an embodiment.

Referring to FIG. 10, in operation 1010, the apparatus 600 for controlling channel access may determine whether the apparatus 600 is at a fairness analysis time point. The fairness analysis time point may include, for example, at least one time point of an initialization time point of the apparatus 600 for controlling channel access or a beacon transmission period.

In operation 1020, when it is determined that the apparatus 600 for controlling channel access is at the fairness analysis time point, the apparatus 600 may determine whether there is a multi-link device (MLD) newly connected to the multi-link (hereinafter, referred to as “new multi-link device”). For example, the apparatus 600 for controlling channel access authenticates a terminal and connects the authenticated terminal to the multi-link according to a connection request from the multi-link device, so that the newly connected device may be identified based on the terminal authentication result. Additionally, the apparatus 600 for controlling channel access may determine whether the terminal is the multi-link device or the single-link device by identifying the number of links connected to the apparatus 600 for controlling channel access.

In operation 1030, when a new multi-link device is identified, the apparatus 600 for controlling channel access may set the minimum CW value of the multi-link device as a specified default value. The specified default value may be the minimum CW value of a specified (or already connected to the communication module 610) legacy station.

In operation 1040, the apparatus 600 for controlling channel access may initialize granting of a packet transmission opportunity between the apparatus 600 for controlling channel access and the new multi-link device. Accordingly, packet transmission between the apparatus 600 for controlling channel access and the new multi-link device may be stopped.

In operation 1050, the apparatus 600 for controlling channel access may determine whether there is a single-link device (legacy station) to transmit/receive data. For example, the apparatus 600 for controlling channel access (AP multi-link device) may determine whether there is a single-link device to transmit/receive data based on information exchanged during the process in which non-AP devices prove their identities to the AP and obtain access rights.

When it is determined that there is the single-link device to transmit/receive data in operation 1050, the apparatus 600 for controlling channel access, in operation 1060, may assign the minimum CW value of the new multi-link device to be less than the minimum CW value of the single-link device.

On the other hand, when it is determined that there is no single-link device to transmit/receive data in operation 1050, the apparatus 600 for controlling channel access, in operation 1070, may assign the minimum CW value of the new multi-link device to be less than the minimum CW value of the apparatus 600 for controlling channel access.

In operation 1080, when the assigning of the minimum CW value to the new multi-link device is completed, the apparatus 600 for controlling channel access may grant a packet transmission opportunity between the apparatus 600 for controlling channel access and the new multi-link device.

In operation 1090, the apparatus 600 for controlling channel access may analyze fairness for each device based on data throughput for the devices connected to the multiple links.

In this manner, the apparatus 600 for controlling channel access according to an embodiment may improve fairness between devices or links by assigning a higher priority (or assigning a lower minimum CW value) to a link or device with relatively low performance (e.g., data throughput) in a multi-link operation environment where the non-AP multi-link devices and the single-link devices coexist.

According to various embodiments disclosed in this document, fairness can be improved in a coexistence situation of a multi-link device and a single-link device. In addition, various effects that are directly or indirectly identified through this document can be provided.

Various embodiments of the present document and terms used therein are not intended to limit technical characteristics described in the present document to specific embodiments, and it should be understood that the present document includes various modifications, equivalents, or substitutions of the embodiments. In description of drawings, similar reference numerals may be used for similar or associated components. A singular form of a noun corresponding to an item may include one or more items unless the context clearly indicates otherwise. In the present document, expressions such as “A or B,” “at least one of A and B,” “at least one of A or B,” “A, B, or C,” “at least one of A, B, and C” and “at least one of A, B, or C” may include any one of or all possible combinations of items listed together in a corresponding one of the expressions. Terms such as “1^{st},” “2^{nd},” “first,” “second,” and the like may be used to simply distinguish a corresponding component from another, and do not limit the components in another aspect (e.g., importance or order). When a certain (e.g., first) component is referred to, with or without the term “functionally” or “communicatively,” as “coupled” or “connected” to another (e.g., second) component, it means that the certain component may be coupled with the other component directly (e.g., by wire), wirelessly, or via a third component.

As used herein, the term “module” may include a unit implemented in hardware, software, or firmware and may interchangeably be used with other terms, for example, “logic,” “logic block,” “part,” and “circuit.” A module may be a single integral component or a minimum unit or part thereof that performs one or more functions. For example, according to an embodiment, a module may be implemented in the form of an ASIC.

Various embodiments of the present document may be implemented as software (e.g., a program) including one or more instructions that are stored in a storage medium (e.g., the memory (e.g., an internal memory or an external memory) 620 of FIG. 6) that is readable by a machine (e.g., an electronic device). For example, the machine (e.g., the processor 630 of the apparatus 600 for controlling channel access) may invoke at least one of the one or more stored instructions from the storage medium and execute the at least one invoked instruction. This allows the machine to be operated to perform at least one function in accordance with the at least one invoked instruction. The one or more instructions may include code generated by a compiler or code executable by an interpreter. The machine-readable storage medium may be provided in the form of a non-transitory storage medium. Here, the term “non-transitory” simply means that the storage medium is a tangible device and does not include a signal (e.g., an electromagnetic wave), but this term does not distinguish between a case where data is semi-permanently stored in the storage medium and a case where data is temporarily stored in the storage medium.

According to an embodiment, methods according to various embodiments set forth herein may be included and provided in a computer program product. The computer program product may be traded as a product between a seller and buyer. The computer program product may be distributed in the form of a machine-readable storage medium (e.g., a compact disc (CD)-ROM) or distributed (e.g., downloaded or uploaded) online via an application store (e.g., PlayStore™) or between two user devices (e.g., smartphones) directly. When distributed online, at least a part of the computer program product may be temporarily generated or at least temporarily stored in a machine-readable storage medium such as a memory of the manufacturer's server, an application store server, or a relay server.

Components according to various embodiments of the present document may be implemented in the form of software or hardware, such as a digital signal processor (DSP), an FPGA, or an ASIC, and perform certain roles. The term “components” is not limited to software or hardware, and each component may be configured to be in an addressable storage medium or to reproduce one or more processors. Examples of components may include components, such as software components, object-oriented software components, and class components, task components, processes, functions, attributes, procedures, subroutines, segments of program code, drivers, firmware, microcode, circuits, data, databases, data structures, tables, arrays, and variables.

According to various embodiments, each (e.g., a module or a program) of the foregoing components may include a single entity or a plurality of entities. According to various embodiments, one or more of the foregoing components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same manner as or a similar manner to a corresponding one of the plurality of components before the integration. According to various embodiments, operations performed by a module, a program, or another component may be carried out sequentially, in parallel, repeatedly, or heuristically, one or more of the operations may be executed in a different order or omitted, or one or more other operations may be added.

What is claimed is:

1. An apparatus for controlling channel access comprising:
a wireless communication circuit capable of multi-link operation through multiple links; and
a processor functionally connected to the wireless communication circuit,
wherein the processor is configured to:
identify types of devices connected to the multiple links at a specified time point; and
assign different minimum contention window (CW) values to the connected devices according to the identified types.

2. The apparatus for controlling channel access of claim 1, wherein the processor assigns a smaller minimum CW value to a multi-link device than a minimum CW value assigned to a single-link device (SLD) among the connected devices.

3. The apparatus for controlling channel access of claim 1, wherein the processor assigns a smaller minimum CW value to a multi-link device among the connected devices than a minimum CW value assigned to the apparatus for controlling channel access.

4. The apparatus for controlling channel access of claim 1, wherein the processor assigns different minimum CW values to the same type of devices among the connected devices based on at least one classification criterion from traffic category, device performance, network environment for each link, and traffic category for each link.

5. The apparatus for controlling channel access of claim 4, wherein the processor assigns the minimum CW value to improve at least one of fairness of the multiple links or fairness of the connected devices based on the at least one classification criterion.

6. The apparatus for controlling channel access of claim 1, wherein the processor sets a minimum CW value of an initially connected device among the connected devices as a default value, and initializes a packet transmit opportunity between the initially connected device and the apparatus for controlling channel access.

7. The apparatus for controlling channel access of claim 6, wherein the processor grants the packet transmit opportunity to the initially connected device after assigning the minimum CW value.

8. The apparatus for controlling channel access of claim 1, wherein the types of the devices include a plurality of devices among a multi-link device, a single-link device, and an AP multi-link device.

9. The apparatus for controlling channel access of claim 1, wherein, when the assignment of the minimum CW value is completed, the processor analyzes fairness of the connected devices based on data throughput of the connected devices.

10. The apparatus for controlling channel access of claim 9, wherein the processor adjusts at least one of the minimum CW value or a CW value based on the analyzed fairness to improve the fairness.

11. A method of controlling channel access by an AP multi-link device supporting a multi-link operation, the method of controlling channel access comprising:
identifying types of devices connected to multiple links at a specified time point; and
assigning different minimum CW values to the connected devices according to the identified types.

12. The method of controlling channel access of claim 11, wherein the assigning of the different minimum CW values includes assigning a smaller minimum CW value to a multi-link device connected to the multiple links than a minimum CW value assigned to a single-link device connected to the multiple links.

13. The method of controlling channel access of claim 12, wherein the assigning of the different minimum CW values includes assigning a smaller minimum CW value to the multi-link device than a minimum CW value assigned to the AP multi-link device.

14. The method of controlling channel access of claim 11, wherein the assigning of the different minimum CW values includes assigning different minimum CW values to the same type of devices among the connected devices based on at least one classification criterion among network environment for each link, traffic category for each link, and traffic category.

15. The method of controlling channel access of claim 11, wherein the assigning of the different minimum CW values includes assigning the minimum CW value to a device to transmit data among the connected devices.

16. The method of controlling channel access of claim 11, wherein the identifying of the types of devices includes:
setting a minimum CW value of an initially connected device among the connected devices as a default value; and
initializing a packet transmit opportunity between the initially connected device and the apparatus for controlling channel access.

17. The method of controlling channel access of claim 16, further comprising, after the assigning of the different minimum CW values,
granting the packet transmit opportunity to the initially connected device.

18. The method of controlling channel access of claim 11, wherein the specified time point is a fairness analysis period,
the method further comprising
analyzing fairness of the connected devices based on data throughput of the connected devices after assigning the minimum CW values.

19. The method of controlling channel access of claim 18, further comprising
adjusting at least one of the minimum CW value or a CW value based on the analyzed fairness to improve the fairness.

20. An apparatus for controlling channel access comprising:
a wireless communication circuit configured to be capable of multi-link operation through multiple links;
a memory configured to store at least one instruction; and
a processor configured to be functionally connected to the wireless communication circuit and the memory,
wherein the at least one instruction causes, when executed, the processor to identify types of devices connected to the multiple links at a specified time point, and to assign different minimum CW values to the connected devices according to the identified types.
